(19) United States
(12) Patent Application Publication
(10) Pub. No.: US 2006/0151564 A1
(43) Pub. Date: Jul. 13, 2006

(54) System and method for dispensing foil or film

(76) Inventor: Bob Rice, San Antonio, TX (US)

Correspondence Address: Alan R. Thiele;Strasburger & Price, LLP, Suite 4400, 901 Main St., Dallas, TX, 75202, US

(21) Appl. No.: 11/312,855

(22) Filed: Dec. 20, 2005

Related U.S. Application Data
(60) Provisional application No. 60/637,534, filed on Dec. 20, 2004.
(60) Provisional application No. 60/644,847, filed on Jan. 18, 2005.

(51) Int. Cl. B26F 3/02

(52) U.S. Cl. 225/16

(57) ABSTRACT

A foil or film dispensing system and method includes two brackets. The brackets work together to hold a roll of foil or film and position a cutting edge for the foil or film. The brackets are sized and constructed for mounting in the unused space of a cabinet.

The application claims priority from Provisional U.S. Patent Application No. 60/637,534 filed Dec. 20, 2004 and Provisional U.S. Patent Application No. 60/644,847 filed Jan. 19, 2005.

### FIELD

The present invention pertains to foil or film dispensers; more particularly the present invention pertains to a mounting system for a foil or film dispenser in normally unused spaces.

### BACKGROUND

Following WW II, the was a dramatic increase of aluminum foil in homes. The uses of aluminum foil became legion ranging from storing food items in a refrigerator to heating items in an oven to lining shelves. Use of aluminum foil became so popular that aluminum foil nearly replaced its predecessor, wax paper. Because of the low price and many uses for aluminum foil, it became difficult to find a household that did not have one or more rolls of aluminum foil ready for use.

Aluminum foil is typically wrapped around a cardboard roll. The wrapped roll of aluminum foil with the cardboard roll contained therein is packaged in a long box. Some long boxes of aluminum foil include a cutting edge over which the aluminum foil may be drawn before cutting off a sheet. The long boxes of unused aluminum foil are often stored in a drawer, or in a pantry—sometimes in a door mounted basket specifically sized for holding long boxes containing aluminum foil.

In commercial establishments where large amounts of aluminum foil are consumed, a large roll of unused aluminum foil may be mounted to a holder positioned near a workspace. Generally, such large rolls of aluminum foil are unsightly and they consume a large amount of space that could be more effectively used to store or pre-position tools or implements.

In the 1950's plastic film became readily available for home use. Because of the great utility of plastic film, most households kept stored rolls of both aluminum foil and plastic film. Much like aluminum foil rolls of plastic film are packaged in a long box. The long box is then stored in a drawer or pantry until needed. In larger applications, a large unsightly roll of plastic film is positioned near a workspace taking up much needed space for tools or implements.

There is therefore a need in the art for a system and method to move a roll of foil or film out of a work area to free up space for tools or implements.

### SUMMARY

The system and method for dispensing foil and film of the present invention moves a roll of foil or film out of a work space into heretofore unused space to provide space for tools or implements.

The foil or film dispensing system and method of the present invention includes two brackets. One bracket provides for rotatably mounting for a roll of foil or film in a space which is generally not used such as the space behind and beneath a horizontally oriented door in a cabinet or the unused space near the underside of a shelf. The bracket which supports the roll of foil or film and allows for dispensing of a section of foil or film in sheets of variable lengths as needed by a user. An edge for cutting the foil or film is also provided.

In the embodiment in which the foil or film or film dispensing system and method of the present invention is mounted behind and beneath a horizontally oriented door, the first bracket is constructed to hold the stored foil or film and is affixed to a frame piece or brace member into which the horizontally oriented door fits when closed. The second bracket is positioned adjacent to the first bracket so that when the door is opened the foil dispensed from the roll of foil or film may be drawn over a cutting edge. When the desired amount of foil or film has been dispensed, the user brings the dispensed amount of foil or film into contact with the cutting edge and cuts the foil. After the cut foil or film sheet has been removed, the horizontally door may be closed masking the presence of the stored foil or film roll.

In the embodiment in which the foil or film dispensing system and method of the present invention is mounted under a shelf, the first bracket is affixed to the bottom of the shelf. A portion of the second bracket provides a mounting for a roll of foil or film in which the roll of foil or film may rotate. The second bracket hingedly affixed to the first bracket includes a cutting edge. The second bracket has two positions with respect to the first bracket. In the up or stored position, the second bracket is positioned against the first bracket. In the down or cutting position, the second bracket drops down to form a small acute angle with respect to the first bracket. In this down position the foil or film may be drawn from the roll of foil or film over the cutting edge and brought into contact therewith. Contact with the cutting edge will cut the foil or film into sheets so that the user may obtain the size of foil or film sheet desired. When the sheet of foil or film of the desired length has been obtained, the second bracket may be moved back up into the stored position against the first bracket.

### BRIEF DESCRIPTION OF THE DRAWING FIGURES

The system and method of the present invention for dispensing foil may be better understood by reference to the drawing figures wherein:

FIG. 1 is a perspective view of the first embodiment of the system and method of the present invention from the outside of a cabinet;

FIG. 2 is a side elevational view, in partial section, taken at line 2-2 of FIG. 1 with the panel in its open position;

FIG. 3 is a side elevational view of the embodiment shown in FIG. 1 with the panel in its closed position;

FIG. 4 is a perspective view of the first embodiment of the invention from the inside of the cabinet showing an alternate design for a tray to store a roll of foil or film;

FIG. 5 is a perspective view of the second embodiment of the system and method of the present invention showing the mounting of the first bracket to the bottom of a cupboard;

FIG. 6 is a side elevational view in partial section taken at line 6-6 of FIG. 5;

FIG. 7 is an exploded perspective view of the second embodiment of the invention.

### DESCRIPTION OF THE EMBODIMENTS

A still better understanding of the system and method of the present invention for dispensing foil or film may be had from the description of the embodiments which follows. In some of the drawing figures, certain portions of either the brackets or the foil or film are showed in dotted lines so that all portions of the embodiments may be clearly understood.

In the first embodiment 10, the system method of the present invention is used in a cabinet 200 such as typically found in the kitchen of many residential dwellings. Such cabinets 200 often include a row of substantially horizontally oriented false panels 202, similar to a drawer front. The false panels 202 are generally located under a work space 204 in either the middle portion of a cabinet 200 or just beneath a counter top. Behind the false panels 202 is an empty space that is typically not used. It is in this empty space that the system and method of the present invention is placed.

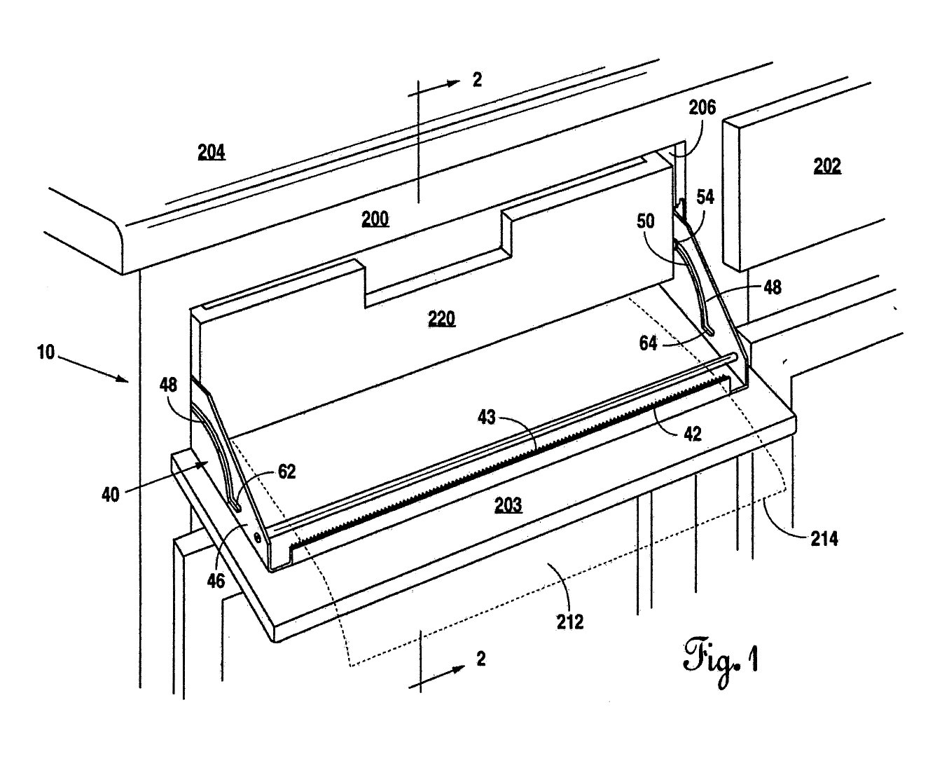

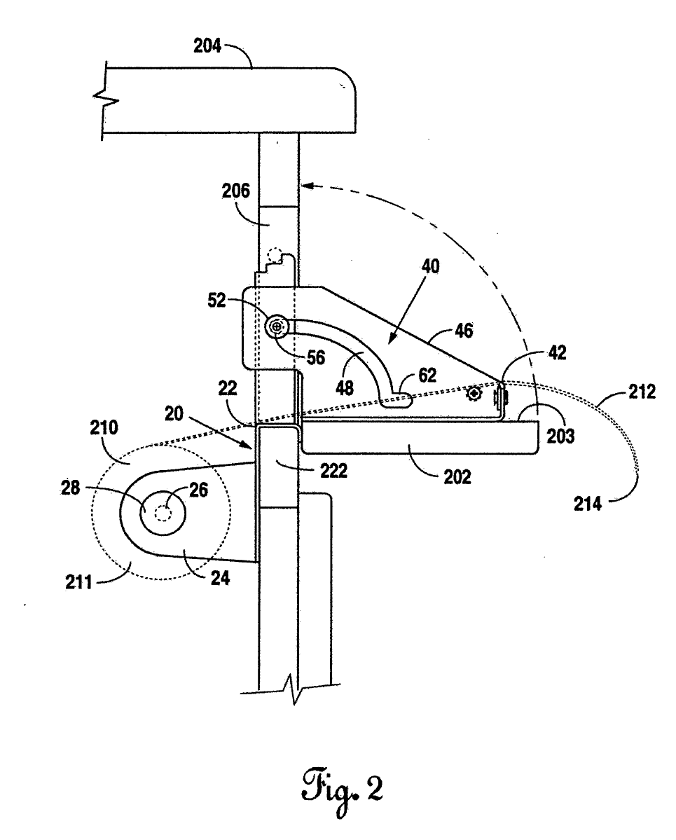

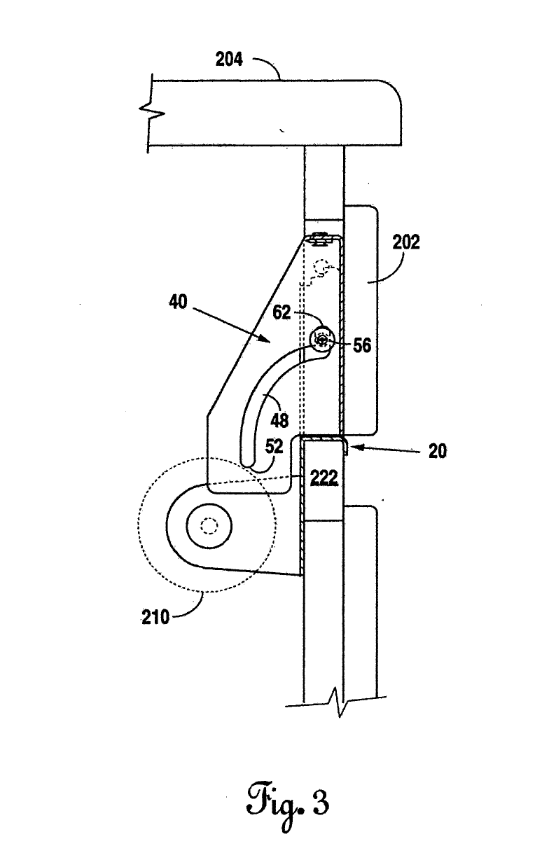

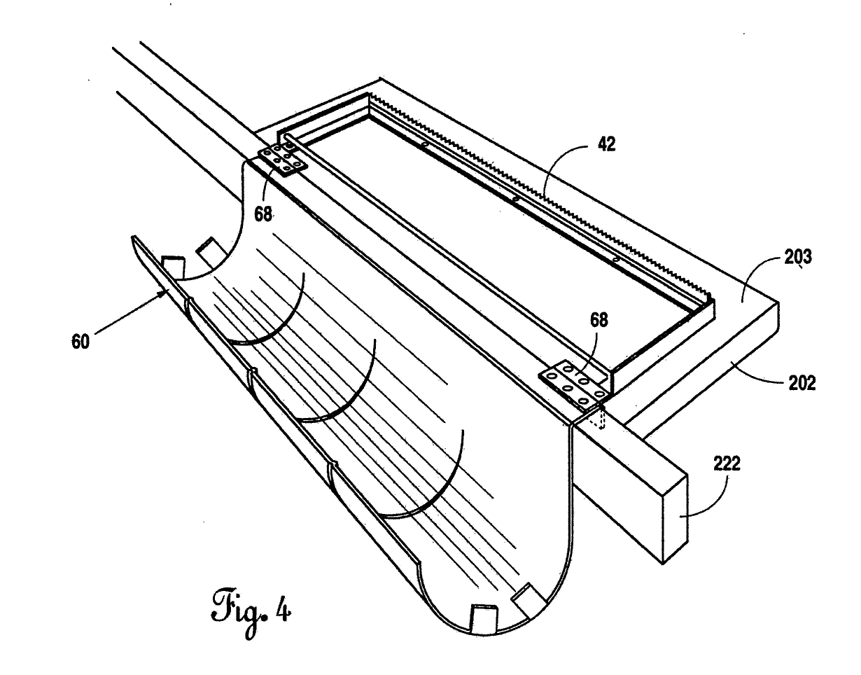

As may be seen in FIGS. 1-4, the false panel portion 202 of the cabinet 200 is pulled down to expose an opening 206 in the front 208 of the cabinet 200. Just beneath the opening 206 and behind the panel 202 is placed a first bracket assembly 20. The first bracket assembly 20 has a mounting portion 22 and a portion 24 for holding a roll of foil or film 210 so that the roll of foil or film 210 may rotate allowing foil or film to be dispensed therefrom. The portion 24 which holds the roll of foil or film may include an axle 26 held in place by ears 28 on either side of the first bracket assembly 20. In the preferred embodiment, the axle 26 runs through the roll of foil or film 210 or alternatively short spindles affixed to each ear 28 may be used to hold the roll of foil or film 210 in position but will still allow it to turn. It is the purpose of the first bracket assembly 20 to position and store a large roll of foil or film 210 in a heretofore unused space.

Positioned on the back 203 of the panel 202 is a second bracket assembly 40. The second bracket assembly 40 holds a foil or film cutting edge 42. The foil or film cutting edge 42 is oriented substantially parallel to the roll of foil or film 210. At either end 44,46 of the second bracket assembly 40 are cam slots 48,50. The cam slots 48,50 engage cams 52,54 affixed to the first bracket assembly 20. Accordingly, when a user opens panel 202 the cam slots 48,50 on the second bracket assembly 40 ride on the cams 52, 54 affixed to the first bracket assembly 20. Contact of the cams 52,54 with the ends 56, 58 of the cam slots 48, 50 positions the open panel 202 in a substantially horizontal position. Contact with the other ends 62,64 of the clam slots 48,50 holds the panel 202 in a substantially vertical position against the face of the cabinet 200 With the panel 202 in this position, the user is able to pull on the edge 214 of the unrolled or dispensed portion of the foil or film 212 and cause a length of foil to be dispensed from the storage roll 210. The dispensed foil or film 212 is then drawn over the foil or film cutting edge 42. When the desired amount of foil or film has been withdrawn, the user exerts a force on the foil or film which brings the foil or film into contact with the foil or film cutting edge 42. A cutting edge 42 with teeth 43 is shown in the preferred embodiment; however, those of ordinary skill in the art will understand that a variety of different types of cutting edges may be used. In some situations it may be necessary to place a guard over the the cutting edge 42. Continual force on the foil or film will cause a cut to propogate across the width of the foil or film thus giving the user the length of a foil or film sheet desired. At this point the panel may be moved back into its closed position. While the edge 214 of the foil or film will remain near the foil or film cutting edge 42, the cutting edge 42 may include a double row of teeth spaced close together so that front row of teeth will cut the foil or film and the rear row of teeth will hold the foil or film near the cutting edge 42.

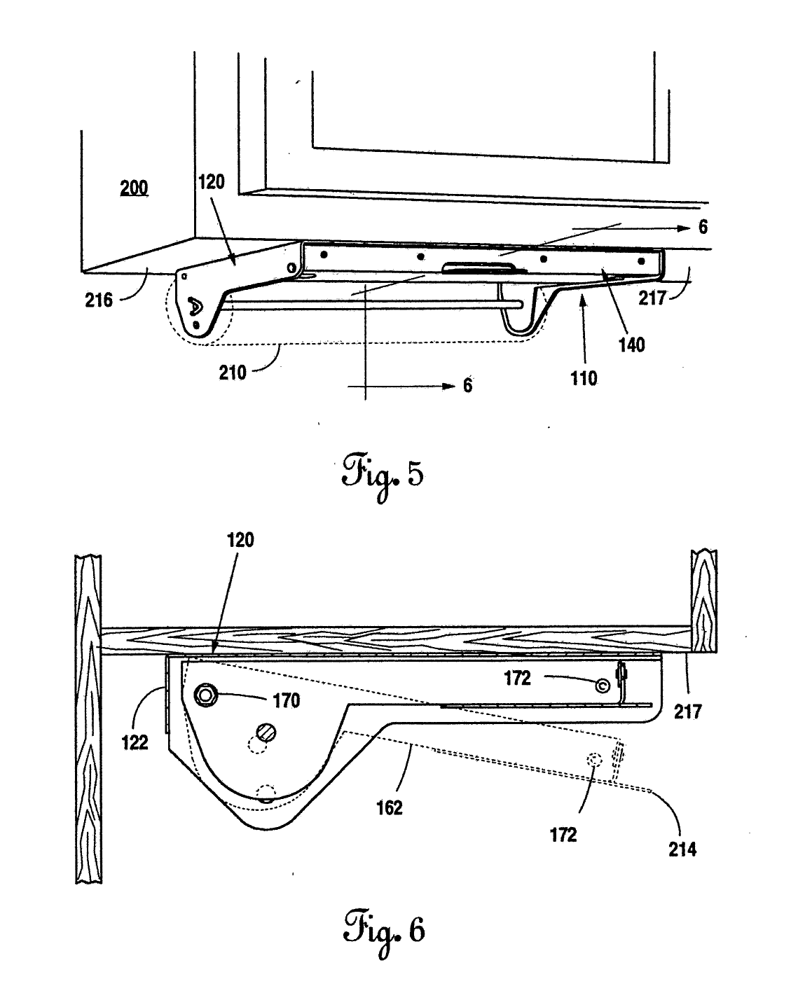

Those of ordinary skill in the art will understand that ears 28 may be formed so as to provide a frictional force on the end 211 of the roll of foil or film 210. Such frictional force will have a braking effect and prevent uncontrolled unrolling of foil or film from the roll 210. Other braking systems to prevent uncontrolled unrolling of foil or film such as bushings positioned on either end of the axle 26 near ears 28 will be well known known to those of ordinary skill in the art. In still other situations, no braking action is required on the roll 210 and a simple substantially U-shaped tray assembly 60 as shown in FIG. 5 may be used to hold the roll of foil or film 210 or a stack of foil or film product stacked like paper towels with back and forth folds. In FIG. 5, panel 202 is hingedly attached 68 to cabinet brace 222.

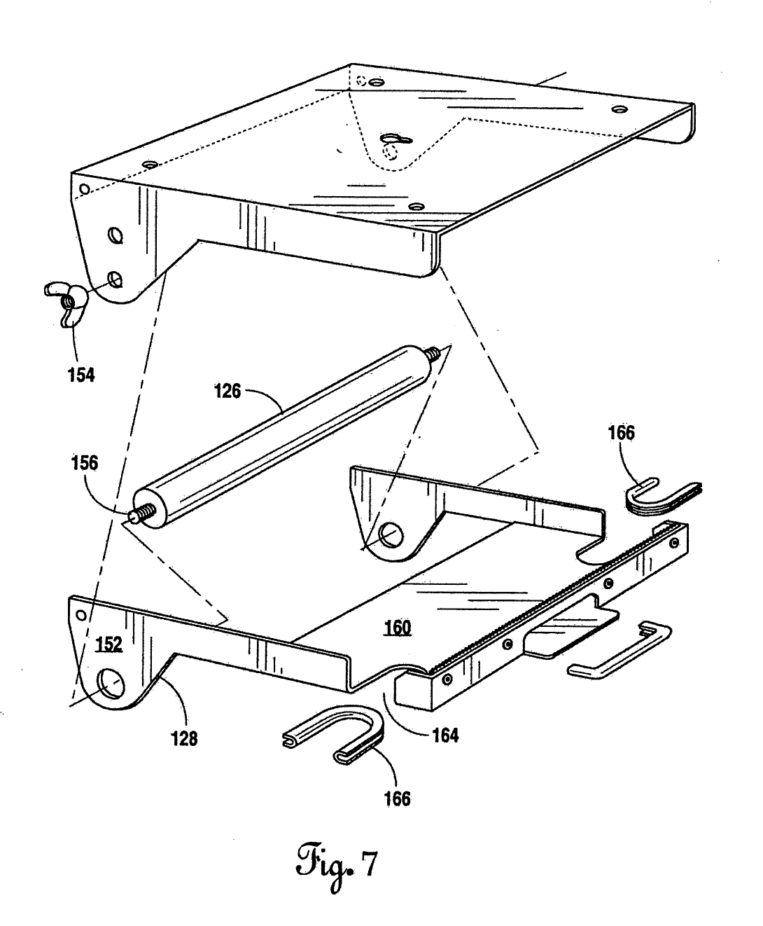

In a second embodiment 110 of the invention the system and method of the present invention shown in FIGS. 5-7 is mounted to a cabinet 200 but instead of being behind one of the false panels 202 on the front 201 of the cabinet 200, the second embodiment 110 is mounted in another space which typically goes unused in a cabinet 200. This is the space under a shelf or under a cupboard 216. The shelf may be the lowest shelf in a cupboard portion 216 of the cabinet 200 or it may be one of the shelves in the cupboard.

As in the first embodiment 10, the system and method of the present invention embodied in the second disclosed embodiment 100 includes two bracket assemblies 120, 140. The first bracket assembly 120 has a mounting portion 122. In the second embodiment 100 the mounting portion 122 of the first bracket assembly 120 is a flat plate 123 which may be attached to the bottom side 217 of a shelf or cupboard 216. Once mounted the first bracket assembly 120 allows for placement of the second bracket assembly 140.

Unlike the first embodiment 10, the second bracket assembly 140 of the second embodiment 110 is hingedly attached 170 to the first bracket assembly 120 and includes a section 152 for holding the roll of foil or film 210. When not in use the second bracket assembly 140 is held in a substantially horizontal position up against the first bracket assembly 120 with one or more detents 172 which use the flexibility of the first bracket assembly 120 to hold the second bracket assembly 140 in position. In the middle portion 141 of the second bracket assembly 140 is a substantially flat tray portion 160 over which the unrolled or dispensed foil 212 is drawn.

To use the second embodiment 110 of the system and method of the present invention the second bracket assembly 140 is pulled down from the first bracket assembly 120 by placing fingers in the substantially U-shaped openings 164 to expose the foil or film cutting edge 142 at the front of the second bracket assembly 140. U-shaped openings 164 may be protected with sections of cut plastic tubing 166. The foil or film 212 is drawn from the roll 210 positioned in the rear portion 152 of the second bracket assembly 140 between mounting ears 128 As in the first embodiment 10 an axle 126 or spindles may be used. In the second embodiment 110 wing nuts 154 are threadably affixed to the ends 156 of the axle 126 to hold the axle 126 in position between the ears 128 on the second bracket assembly 140. As explained with regard to the first embodiment 10, bushings or some other system may be used to prevent uncontrolled unrolling of stored foil or film. Pulling on the edge 214 of the unrolled or dispensed portion of the foil or film 212 will draw the foil or film over the foil or film cutting edge 142. When the desired length of foil or film has been obtained the foil or film is pulled down against the foil or film cutting edge 142 so that the desired length of a foil or film sheet may be removed from the roll of stored foil or film 210. The cutting edge 142 may include teeth, prongs, or a straight edge depending on the type of foil or film to be cut into sheets. The second bracket assembly 140 is then moved upwardly to be put back in contact with the first bracket assembly 120 and held in that position by detents 172.

The edge 214 of the foil or film remains at the foil or film cutting edge 142 ready for use as needed. As explained with respect to the first embodiment 10, multiple rows of teeth may be used, one to cut the foil or film, the other to hold the foil or film once cut.

Those of ordinary skill in the art will understand that a variety of foil or film products may be used with the system and method of the present invention to include aluminum foil, plastic film, wax paper or any other type of film or paper product available in rolls or stacked with back an forth folds. If sufficient space is available in a cabinet, a user may make plural use of the system and method of the present invention for multiple rolls of different types of foil or film.

It has been found that commercial sized aluminum foil rolls having up to 500 feet of available foil may be used with the system and method of the present invention. If a plastic film is used, commercial size roll lengths of up to 750 feet can be accommodated. Thus, instead of frequently replacing rolls of foil or film, a user of the system and method of the present invention will be able to save money by buying a large quantity of foil wherein the cost per unit length is much less than smaller rolls. It is expected that some users will be able to go a year or more without having to replace a roll of foil or film. The width of the roll of foil or film that can be used depends on the width of the available space in the cabinet.

While the system and method of the present invention has been described according to the foregoing embodiments, those of ordinary skill in the art will understand that still other embodiments have been enabled by the foregoing disclosure. Such other embodiments shall be included within the scope and meaning of the appended claims.

I claim:

1. A system for dispensing a foil or film product from stored foil or film product positioned in a cabinet through substantially horizontally oriented doors formed therein, said system comprising:
a first bracket including a support for the storage of foil or film product, said support constructed and arranged to allow the foil or film product to be dispensed so that foil or film product may be removed through the substantially horizontally oriented door;
said first bracket being constructed and arranged for positioning within the cabinet to position the foil or film product behind and beneath the substantially horizontally oriented door;
a second bracket including an edge for cutting the foil, said second bracket constructed and arranged for hinged mounting to said first bracket;
whereby a user can open the substantially oriented door, dispense a length of foil from the stored foil or film product held by said first bracket, cut the foil, and return the door to its closed position.

2. The system as defined in claim 1 wherein said storage of foil or film product is constructed and arranged for storage of a roll of foil or film product.

3. The system as defined in claim 2 wherein said first bracket is constructed and arranged to rotatably mount said roll of foil or film product.

4. The system as defined in claim 3 wherein said rotatable mount prevents uncontrolled unrolling of said roll of foil or film product.

5. The system as defined in claim 1 wherein the connection of said first and said second brackets provides a hinged mounting for the substantially horizontally oriented door.

6. A method for dispensing foil or film product from a cabinet having hinged horizontally oriented doors, said method comprising the steps of:
mounting a first bracket substantially beneath and behind the horizontally oriented door for storing the foil or film product;
mounting a second bracket having a foil or film cutting edge to said horizontally oriented door;
whereby a sheet of foil or film may be dispensed by opening the horizontally oriented door, pulling out a section of foil or film, cutting the foil or film into a sheet with said foil or film cutting edge.

7. The method as defined in claim 6. wherein said first bracket is constructed and arranged to store a roll of foil or film product.

8. The method as defined in claim 7 wherein said first bracket rotatably mounts the roll of foil or film product.

9. The method as defined in claim 8 wherein said first bracket prevents the uncontrolled unrolling of the roll of foil or film product.

10. The method as defined in claim 6 wherein said first bracket and said second bracket are mounted together for controlling the opening of the horizontally oriented door.

11. A dispenser system for mounting stored foil or film on the bottom of a shelf, said dispenser system comprising:
a first bracket constructed and arranged for mounting to the bottom of the shelf;
a second bracket hingedly connected to said first bracket, said second bracket constructed and arranged for holding the stored foil or film;
said second bracket further including a foil or film cutting edge;
said hinged connection between said first bracket and said second bracket permitting said second bracket to be maintained in a stored positioned with respect to said first bracket and a foil or film dispensing position with respect to said first bracket.

12. The dispenser system as defined in claim 11 wherein the foil or film is stored on a roll.

13. The dispenser system as defined in claim 12 wherein said second bracket is constructed and arranged for the storage of said roll.

14. The dispenser system as defined in claim 13 wherein said second bracket further prevents the uncontrolled unrolling of said roll.

15. The dispenser system as defined in claim 11 wherein said foil or film cutting edge includes teeth.

16. A method for dispensing foil or film from the bottom of a shelf, said method comprising the steps of:
mounting a first bracket constructed and arranged to mount to the bottom of a shelf;
hingedly mounting a second bracket having a foil or film storage portion and a foil or film cutting edge to said first bracket;
whereby said second bracket may be stored against said first bracket and then moved to a cutting position wherein said a piece of foil or film may be cut using said foil or film cutting edge.

17. The method as defined in claim 16 further including the step of storing the foil or film on a roll.

18. The method as defined in claim 17 wherein said second bracket is constructed and arranged to store said roll.

19. The method as defined in claim 18 wherein said second bracket is constructed and arranged to prevent uncontrolled unrolling of said roll.

20. The method as defined in claim 16. wherein said foil or film cutting edge includes teeth.
